(19) United States
(12) Patent Application Publication
(10) Pub. No.: US 2026/0018732 A1
(43) Pub. Date: Jan. 15, 2026

(54) ARRANGEMENT APPARATUS FOR BATTERY CELL ASSEMBLY AND ASSEMBLY APPARATUS FOR BATTERY MODULE HAVING THE SAME AND ARRANGEMENT METHOD OF BATTERY CELL ASSEMBLY

(71) Applicant: SK ON CO., LTD., Seoul (KR)

(72) Inventors: Jae Min JO, Daejeon (KR); Jae Hyeon KIM, Daejeon (KR); Seok Hui YUN, Daejeon (KR); Jae Won CHOI, Daejeon (KR); Jung Hyun LEE, Daejeon (KR); Eun Seo CHOI, Daejeon (KR)

(21) Appl. No.: 19/263,510

(22) Filed: Jul. 9, 2025

(30) Foreign Application Priority Data
Jul. 12, 2024 (KR) 10-2024-0092361

(51) Int. Cl. H01M 50/291; H01M 50/178; H01M 50/211; H01M 50/505

(52) U.S. Cl. CPC H01M 50/291; H01M 50/178; H01M 50/211; H01M 50/505

(57) ABSTRACT

An arrangement apparatus for a battery cell assembly according to an embodiment of the present disclosure may include: to arrange the battery cell assembly including a plurality of battery cell in which an electrode assembly is accommodated inside an external material and an electrode lead is exposed to an outside of the external material, a plurality of terrace arrangement members spaced apart from each other and interposed between the plurality of battery cells; and a first movement portion moving the plurality of terrace arrangement members in a plurality of directions and bringing the plurality of terrace arrangement members into contact with a terrace region of the external material.

### CROSS-REFERENCE TO RELATED APPLICATION(S)

This patent document claims the priority and benefits of Korean Patent Application No. 10-2024-0092361 filed on Jul. 12, 2024, the disclosure of which is incorporated herein by reference in its entirety.

### TECHNICAL FIELD

The present disclosure relates to an arrangement apparatus for a battery cell assembly, an assembly apparatus for a battery module having the same and an arrangement method of the battery cell assembly.

### BACKGROUND

Batteries are widely used in small electronic devices such as mobile phones and laptop computers as well as in medium and large mechanical devices such as electric vehicles (EVs), and have the advantage of being rechargeable and reusable.

An electrode assembly may be formed by an electrode plate including a cathode plate and an anode plate, and a separator separating the cathode plate and the anode plate. The electrode assembly may be accommodated in an external material, an electrolyte may be injected thereinto, and then the external material may be sealed to manufacture a pouch-type battery cell. In the pouch-type battery cell, an electrode lead connected to the electrode assembly may be exposed to the outside of the external material.

A battery cell assembly may be formed by stacking or arranging a plurality of battery cells, and a busbar may be connected to the battery cell assembly to form a battery module and/or a battery pack.

In this case, when the electrode leads of a plurality of battery cells overlap each other, the assembly quality between the electrode leads and the busbar may be deteriorated, and a short circuit may occur.

Additionally, the external material in the form of a sheet or a film including aluminum, or the like, may experience a spring back phenomenon during the handling of the battery cell, which may result in a deterioration in shape freezing properties.

### SUMMARY

According to an aspect of the present disclosure, provided are an arrangement apparatus for a battery cell assembly capable of arranging a plurality of battery cells in a given position, an assembly apparatus for a battery module having the same and an arrangement method of the battery cell assembly.

Additionally, according to an aspect of the present disclosure, provided are an arrangement apparatus for a battery cell assembly capable of improving the quality and safety of a battery cell assembly and a battery module, an assembly apparatus for a battery module having the same and an arrangement method of the battery cell assembly.

Additionally, the present disclosure may be widely applied in green technology fields such as solar power generation and wind power generation.

Additionally, the present disclosure may be applied to eco-friendly devices such as eco-friendly electric vehicles and hybrid vehicles for ameliorating the effects of climate change by suppressing air pollution and greenhouse gas emissions.

An arrangement apparatus for a battery cell assembly according an embodiment of the present disclosure may include: to arrange the battery cell assembly including a plurality of battery cell in which an electrode assembly is accommodated inside an external material and an electrode lead is exposed to an outside of the external material, a plurality of terrace arrangement members spaced apart from each other and interposed between the plurality of battery cells; and a first movement portion moving the plurality of terrace arrangement members in a plurality of directions and bringing the plurality of terrace arrangement members into contact with a terrace region of the external material.

In an embodiment, the arrangement apparatus for a battery cell assembly may further include: a plurality of lead arrangement members extending in a direction oriented toward the electrode leads; and a second movement portion moving the plurality of lead arrangement members between the plurality of electrode leads.

In an embodiment, the first movement portion may move the plurality of terrace arrangement members in a first direction, intersecting a thickness direction of the electrode lead and allowing the plurality of terrace arrangement members to be entered between the battery cells, and move the plurality of terrace arrangement members in the thickness direction of the electrode lead, or a direction, intersecting the thickness direction of the electrode leads with respect to the first direction.

In an embodiment, in a state in which the terrace region is interposed between the plurality of terrace arrangement members, the plurality of terrace arrangement members may be moved in a second direction, intersecting the first direction, and in a third direction opposite to the second direction.

In an embodiment, in state in which a plurality of terrace regions of a plurality of battery cells adjacent to each other are parallel to each other, a maximum thickness of the plurality of terrace arrangement members may be less than or equal to a shortest distance of the plurality of terrace regions.

In an embodiment, in at least one of the plurality of terrace arrangement members, a thickness of an end thereof may be a minimum thickness.

In an embodiment, at least one of the plurality of terrace arrangement members may have a thickness that linearly decreases toward an end of the terrace arrangement member.

In an embodiment, the first movement portion may move the plurality of terrace arrangement members in the first direction so that ends of the plurality of terrace arrangement members initially face or contact the external material, and move the plurality of terrace arrangement members in the second direction and the third direction so as to pressurize the terrace region with a region having the maximum thickness.

In an embodiment, the plurality of terrace arrangement members may be formed of a material including at least one of a resin or mica.

In an embodiment, the second movement portion may move the plurality of lead arrangement members in a fourth direction, intersecting a thickness direction of the electrode lead and allowing the plurality of lead arrangement members to be entered between the battery cells, and move the plurality of lead arrangement members in the thickness direction of the electrode lead or a fifth direction, intersecting a height direction of the electrode lead with respect to the fourth direction.

In an embodiment, the second movement portion moves the plurality of lead arrangement members in a plurality of directions, and the plurality of directions may include a fourth direction in which the plurality of lead arrangement members entered between the battery cells, and a fifth direction, intersecting the fourth direction.

In an embodiment, the second movement portion may move the plurality of lead arrangement members in the fourth direction after at least one of the plurality of terrace arrangement members is in close contact with the terrace region.

In an embodiment, in state in which a plurality of electrode leads of a plurality of battery cells adjacent to each other are parallel to each other, a maximum thickness of the plurality of lead arrangement members is less than or equal to a shortest distance between the plurality of electrode leads.

In an embodiment, the first movement portion may include: a first support frame supporting the plurality of terrace arrangement members to be spaced apart from each other; and a first actuator connected to the first support frame and moving the first support frame.

In an embodiment, the second movement portion may include: a second support frame supporting the plurality of lead arrangement members; and a second actuator connected to the second support frame and moving the second support frame.

In an embodiment, the first movement portion may discharge the plurality of terrace arrangement members to the outside of the battery cell, and the second movement portion may discharge the plurality of lead arrangement members to the outside of the battery cell by moving the plurality of lead arrangement members in the same direction as the plurality of terrace arrangement members.

Meanwhile, in another aspect, the present disclosure discloses an assembly apparatus for a battery module. An assembly apparatus for a battery module according to an embodiment of the present disclosure may include: to assemble a busbar assembly to a battery cell assembly including a plurality of battery cell in which an electrode assembly is accommodated inside an external material and an electrode lead is exposed to an outside of the external material, the arrangement apparatus for a battery cell assembly of claim 1; and a busbar movement portion moving the busbar assembly in a direction oriented toward the electrode lead after the first movement portion pressurizes the terrace region with the plurality of terrace arrangement members.

In an embodiment, the busbar movement portion may move the busbar assembly while the first movement portion discharges the plurality of terrace arrangement members to the outside of the battery cell, so that the busbar assembly faces the electrode lead.

In an embodiment, the busbar movement portion may move the busbar assembly in a direction in which the first portion discharges the plurality of terrace movement arrangement members to the outside of the battery cell.

Meanwhile, in another aspect, the present disclosure discloses an arrangement method of a battery cell assembly.

An arrangement method of a battery cell assembly according to an embodiment of the present disclosure may be an arrangement method of a battery cell assembly including a plurality of battery cell in which an electrode assembly is accommodated inside an external material and an electrode lead is exposed to an outside of the external material, and may include: a terrace arrangement operation of interposing a terrace region provided in the external material between a plurality of terrace arrangement members; and a terrace pressurizing operation of pressurizing the terrace region with a plurality of terrace arrangement members in a thickness direction of the electrode lead.

In an embodiment, the terrace pressurizing operation may include: a moving operation of moving the plurality of terrace arrangement members in a state in which the terrace region is pressurized with the plurality of terrace arrangement members.

According to an aspect of the present disclosure, provided are an arrangement apparatus for a battery cell assembly capable of arranging a plurality of battery cells in a given position, an assembly apparatus for a battery module having the same and an arrangement method of the battery cell assembly.

Additionally, according to an aspect of the present disclosure, provided are an arrangement apparatus for a battery cell assembly capable of improving the quality and safety of a battery cell assembly and a battery module, an assembly apparatus for a battery module having the same and an arrangement method of the battery cell assembly.

Additionally, the present disclosure may be widely applied in green technology fields such as solar power generation and wind power generation.

Additionally, the present disclosure may be applied to eco-friendly devices such as eco-friendly electric vehicles and hybrid vehicles for ameliorating the effects of climate change by suppressing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 schematically illustrates a state in which an arrangement apparatus for a battery cell assembly based on an embodiment of the present disclosure is applied to a battery cell assembly.

FIG. 2 illustrates an operating state of an arrangement apparatus for a battery cell assembly based on an embodiment of the present disclosure as a front view.

FIG. 3 illustrates an operating state of an arrangement apparatus for a battery cell assembly based on an embodiment of the present disclosure as a plan view.

FIG. 4 illustrates an operating state of an arrangement apparatus for a battery cell assembly based on an embodiment of the present disclosure as a plan view. In FIG. 4, a side sealing portion is also excluded.

FIG. 5 illustrates an operating state of an arrangement apparatus for a battery cell assembly based on another embodiment of the present disclosure as a side view.

FIG. 6 illustrates an operating state of an arrangement apparatus for a battery cell assembly based on another embodiment of the present disclosure as a front view.

FIG. 7 illustrates an operating state of the arrangement apparatus for a battery cell assembly illustrated in FIG. 6 as a front view.

FIG. 8 is a plan view illustrating an operating state of the arrangement apparatus for a battery cell assembly illustrated in FIG. 6.

FIG. 9 is a schematic side view of an arrangement apparatus for a battery cell assembly based on another embodiment of the present disclosure.

FIG. 10 is a schematic plan view of an arrangement apparatus for a battery cell assembly based on another embodiment of the present disclosure.

FIG. 11 is a schematic exploded perspective view of an assembly apparatus for a battery module based on an embodiment of the present disclosure.

FIG. 12 is a schematic front view of the assembly apparatus for a battery module illustrated in FIG. 11, and schematically illustrates an operating state.

FIG. 13 is a schematic illustration of an arrangement method for a battery cell assembly based on an embodiment of the present disclosure.

FIG. 14 is a schematic illustration of an arrangement method for a battery cell assembly based on another embodiment of the present disclosure.

### DETAILED DESCRIPTION

In order to help understand the description of an embodiment of the present disclosure, elements described with the same symbol in the attached drawings are the same elements. Some components of the attached drawings are exaggerated, omitted, or schematically illustrated, and sizes of each component do not completely reflect actual sizes.

Additionally, in order to clarify the gist of the present disclosure, descriptions of elements and techniques well known by conventional techniques will be omitted, and hereinafter, the present disclosure will be described in detail with reference to the attached drawings.

Hereinafter, an X-axis illustrated in the drawing is a width direction or a length direction of a battery cell 10, a Y-axis is a thickness direction of the battery cell 10, and a Z-axis is a height direction of the battery cell 10. However, these are directions arbitrarily set for convenience of understanding, and the aforementioned directions may be changed.

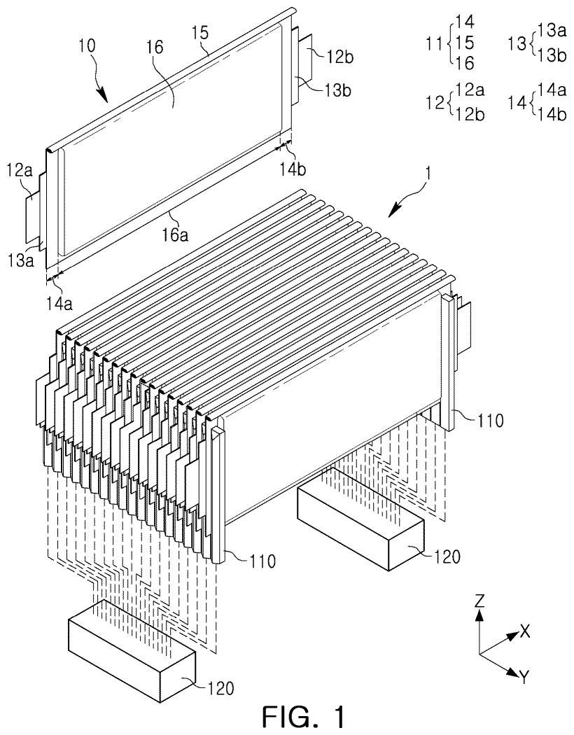

FIG. 1 schematically illustrates a state in which an arrangement apparatus 100 for a battery cell assembly based on an embodiment of the present disclosure is applied to a battery cell assembly 1.

As shown in FIG. 1, an arrangement apparatus 100 for a battery cell assembly according to an embodiment of the present disclosure may include, to arrange a battery cell assembly 1 in which an electrode assembly is accommodated inside an external material 11 and an electrode lead 12 is exposed to an outside of the external material 11, a plurality of terrace arrangement members 110 spaced apart from each other and interposed between the plurality of battery cells 10, and a first movement portion 120 moving the plurality of terrace arrangement members 110 in a plurality of directions and bringing the plurality of terrace arrangement members 110 into contact with a terrace region 14 of the external material 11.

The battery cell assembly 1 may include a plurality of battery cells 10. The number of battery cells 10 included in the battery cell assembly 1 is not necessarily limited by the present disclosure, and the plurality of battery cells 10 may be stacked or arranged.

In this case, pads, and the like, for providing surface pressure or performing heat transfer may be further provided between the plurality of battery cells 10. Additionally, the plurality of battery cells 10 may be bonded or connected to each other by a tape, an adhesive, or the like.

The battery cell 10 may have a form in which a cathode, an anode, a separator, and an electrolyte are present inside the external material 11. The cathode and the anode may be isolated from each other by the separator, and an electrode assembly may be formed by the cathode, the anode and the separator. Such an electrode assembly may be accommodated in the external material 11, and a region in which the electrode assembly is accommodated in the external material 11 may be an electrode assembly accommodation region 16. The electrode assembly accommodation region 16 may be formed by an inner surface of the external material 11.

In an embodiment, the battery cell 10 may be a pouch-type battery cell 10. Additionally, in an embodiment, the battery cell 10 may be a bidirectional battery cell 10. In the bidirectional battery cell 10, a plurality of electrode leads 12 may be withdrawn from different corners or edges of the external material 11.

The plurality of electrode leads 12 may include a first electrode lead 12a withdrawn from one edge of the external material 11 and a second electrode lead 12b withdrawn from the other edge of the external material 11.

The first electrode lead 12a may be electrically connected to a cathode plate and exposed to the outside of the external material 11, and the second electrode lead 12b may be electrically connected to an anode plate and exposed to the outside of the external material 11. However, this is not necessarily limited by the present disclosure, and the cathode plate may be connected to the second electrode lead 12b, and the anode plate may be connected to the first electrode lead 12a.

The first electrode lead 12a may be electrically insulated from the external material 11 by a first lead film 13a, and the second electrode lead 12b may be electrically insulated from the external material 11 by a second lead film 13b. For this purpose, the first lead film 13a and the second lead film 13b may be provided with a material having electrical insulation properties.

The external material 11 may be in the form of a film in which polyethyleneterephthalate (PET), nylon, and aluminum are stacked.

The battery cell 10 may have a sealed structure by folding the external material 11 so that both ends of the external material 11 are in contact with each other, and thermally fusing an overlapping region in which the remaining three edges, except for an edge at which a folding line is formed in the external material 11, overlap each other. In the sealed external material 11, the first electrode lead 12a and the second electrode lead 12b may be exposed to the outside of the external material 11.

For example, a side sealing portion 15 disposed to be parallel to a width direction (X-axis direction) of the battery cell 10 in the external material 11 may be rolled or folded and may be fixed to an outer surface of the external material 11.

A plurality of terrace regions 14 may be disposed in the electrode assembly accommodation region 16 on the outer surface of the external material 11. The plurality of terrace regions 14 may include a first terrace region 14a adjacent to the electrode assembly accommodation region 16 in an −X-direction and a second terrace region 14b adjacent to the electrode assembly accommodation region 16 in an +X-direction.

A terrace region 14 may be formed in the external material 11, and at least a partial region of the terrace region 14 may be formed on the outer surface of the external material 11. The terrace region 14 may be a remaining region of the external material 11 excluding the electrode assembly accommodation region 16. The terrace region 14 may not face the electrode assembly accommodated inside the external material 11.

The terrace region 14 may be exposed to the outer surface of the external material 11. The terrace region 14 may include a region in which the external material 11 is sealed. In this case, the side sealing portion 15 may be excluded from the terrace region 14.

In an inner surface of the first terrace region 14a, a sealed region of the external material 11, at least a partial region of the first electrode lead 12a, and at least a partial region of the first lead film 13a may be disposed.

In an inner surface of the second terrace region 14b, a sealed region of the external material 11, at least a partial region of the second electrode lead 12b, and at least a partial region of the second lead film 13b may be disposed.

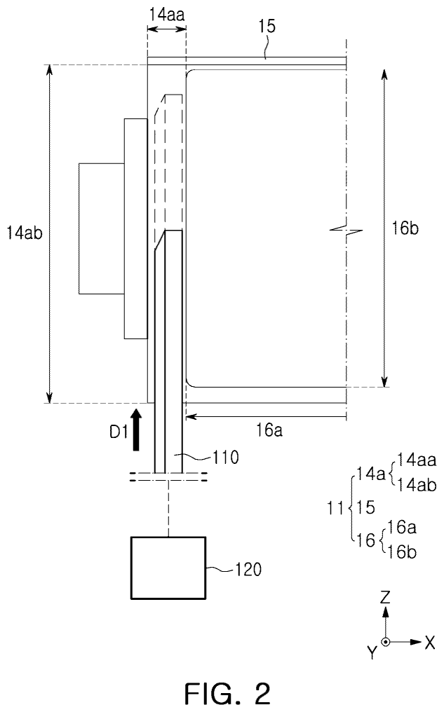

In the battery cell 10, a width 16a of the electrode assembly accommodation region 16 in the X-axis direction may be wider than a width 14aa (see FIG. 2) of the first terrace region 14a in the X-axis direction and a width of the second terrace region 14b in the X-axis direction.

The width 14aa (see FIG. 2) of the first terrace region 14a may be from an edge of the external material 11 in the −X-direction to a position before the electrode assembly accommodation region 16 in a direction (+X-direction) oriented toward the electrode assembly accommodation region 16.

The width of the second terrace region 14b may be from an edge of the external material 11 in the +X-direction to a position before the electrode assembly accommodation region 16 in a direction (−X-direction) oriented toward the electrode assembly accommodation region 16.

The edge of the external material 11 in the −X-direction may be disposed to be opposite to the edge of the external material 11 in the +X-direction.

The terrace arrangement member 110 may be interposed between a pair of battery cells 10. For example, one terrace arrangement member 110 may be disposed between a pair of battery cells 10. The terrace arrangement member 110 may be interposed between a pair of terrace regions 14 of a pair of battery cells 10 adjacent to each other. However, a pair of terrace arrangement members 110 disposed in an outermost portion of the battery cell assembly 1 may face one terrace region 14.

In an embodiment, a plurality of battery cells 10 may be stacked so that a plurality of first terrace regions 14a face each other and a plurality of second terrace regions 14b face each other.

The plurality of first terrace regions 14a may face each other in a Y-axis direction, and the plurality of second terrace regions 14b may face each other in the Y-axis direction.

The terrace arrangement member 110 may have a predetermined height in a height direction (Z-axis direction) of the battery cell 10. The terrace arrangement member 110 may be disposed between a plurality or a pair of first terrace regions 14a and may be disposed between a plurality or a pair of second terrace regions 14b.

In this case, the plurality of terrace arrangement members 110 may be spaced apart from each other by a predetermined distance in the Y-axis direction. In an embodiment, the plurality of terrace arrangement members 110 disposed at the first terrace region 14a may be spaced apart from each other by a separation distance in the Y-axis direction between the pair of first terrace regions 14a, and the plurality of terrace arrangement members 110 disposed at the second terrace region 14b may be spaced apart from each other by a separation distance in the Y-axis direction between the pair of second terrace regions 14b.

The first movement portion 120 may include a plurality of first movement portions 120. Among the plurality of first movement portions 120, one of the first movement portions 120 may be connected to the plurality of terrace arrangement members 110 disposed at the first terrace region 14a, and the other first movement portion 120 may be connected to the plurality of terrace arrangement members 110 disposed at the second terrace region 14b.

Hereinafter, the first movement portion 120 disposed at the first terrace region 14a and a plurality of terrace arrangement members 110 connected to the first movement portion 120, the first terrace region 14a, and the first electrode lead 12a will be described as examples, but the description below will be applied to the other first movement portion 120 disposed at the second terrace region 14b and a plurality of terrace arrangement members 110 connected to the other first movement portion 120, the second terrace region 14b, and the second electrode lead 12b in the same principle.

The first movement portion 120 may move a plurality of terrace arrangement members 110 simultaneously, or may move the plurality of terrace arrangement members 110 individually or independently. However, this is not necessarily limited by the present disclosure.

The first movement portion 120 may move the plurality of terrace arrangement t members 110 in a plurality of directions, and the plurality of directions may include a direction in which the plurality of terrace arrangement members 110 enter the first terrace region 14a, a direction in which the first terrace region 14a is pressurized with a plurality of terrace members, and a direction in which the plurality of terrace arrangement members 110 are discharged outside the first terrace region 14a.

Additionally, in an embodiment, the first movement portion 120 may be implemented by combinations of a motor, a gear, a ball screw, an LM guide, and the like, and may be implemented by a Computer Aided Engineering (CAE) such as a robot arm, Computer Aided Design (CAD), and Computer Aided Manufacturing (CAM).

As described above, the first movement portion 120 may move a plurality of terrace arrangement members 110 disposed outside the battery cell 10 so that the plurality of terrace arrangement members 110 face the battery cell 10 or the terrace region 14.

Additionally, the first movement portion 120 may allow the plurality of terrace arrangement members 110 disposed outside the battery cell 10 to be entered between the battery cells 10. In this case, a space between the battery cells 10 may include a space between a pair of first terrace regions 14a.

However, as described above, the terrace arrangement member 110 existing in an outermost portion may face one first terrace region 14a.

In an embodiment, when moving the plurality of terrace arrangement members 110, the first movement portion 120 may move the plurality of terrace arrangement members 110 so that one pair of terrace arrangement members 110 may pressurize one first terrace region 14a. In this case, one first terrace region 14a may have a form clamped by one pair of terrace arrangement members 110 adjacent to each other.

According thereto, the first terrace region 14a may be pressurized by the terrace arrangement member 110, and compressive residual stress may be applied to the first terrace region 14a. Accordingly, a springback phenomenon of the external material 11 may be suppressed. This may contribute to improving the quality of the battery cell 10 and the battery cell assembly 1.

The battery cell 10 having suppressed springback may improve the shape fixation of the external material 11 and may prevent deformation such as bending and warping of the external material 11. Accordingly, deformation such as bending and warping of the terrace region 14 of the external material 11 may also be prevented. This may contribute to preventing deformation of the first terrace region 14a supporting the first electrode lead 12a, and may further prevent bending, warping, misalignment, and the like, of the first electrode lead 12a. In the battery cell 10 having suppressed springback, the first electrode lead 12a may be maintained in a state parallel to the X-axis.

FIG. 2 illustrates an operating state of the arrangement apparatus 100 for a battery cell assembly based on an embodiment of the present disclosure as a front view.

FIG. 2 is a schematic view, and FIG. 2 illustrates a first electrode lead 12a, a first terrace region 14a, and a portion of an electrode assembly accommodation region 16 of a battery cell 10, but a second electrode lead 12b and a second terrace region 14b of the battery cell 10 may extend in the +X-direction of the electrode assembly accommodation region 16, and may have the same structure as that illustrated in FIG. 2. Additionally, the same principle as that illustrated in FIG. 2 may also be applied to a terrace arrangement member 110 disposed in the second terrace region 14b.

Additionally, for the convenience of understanding, FIG. 2 illustrates only one battery cell 10 and illustrates only one terrace arrangement member 110. However, the technical idea illustrated in FIG. 2 may be equally applied to a plurality of terrace arrangement members 110, and one terrace arrangement member 110 may be interposed between a pair of first terrace regions 14a. Hereinafter, an embodiment of the present disclosure will be described based on this premise.

The first movement portion 120 may move the terrace arrangement member 110 in a plurality of directions. In an embodiment, the plurality of directions may include a first direction D1 in which the terrace arrangement member 110 enters between a plurality of battery cells 10, for example, between a pair of battery cells 10.

The first direction D1 may be a direction parallel to a height direction (Z-axis direction) of the battery cells 10. The first movement portion 120 may move the terrace arrangement member 110 in the +Z-direction. The first movement portion 120 may move the terrace arrangement member 110 in the first direction D1 in a state in which the terrace arrangement member 110 is in contact with the first terrace region 14a, or may move the terrace arrangement member 110 in the first direction D1 in a state in which the terrace arrangement member 110 is not in contact with the first terrace region 14a.

Accordingly, the plurality of battery cells 10 may be arranged so that a gap in the Y-axis direction between the plurality of first terrace regions 14a is greater than a thickness of the terrace arrangement member 110 in the Y-axis direction. Accordingly, each of the plurality of first terrace regions 14a may be arranged to be parallel to an X-axis.

In an embodiment, in the terrace arrangement member 110 that has entered between the first terrace regions 14a, an end thereof in a +Z-direction may be disposed in a lower portion of a side sealing portion 15. Accordingly, the sealing quality of the battery cell 10 may be prevented from being deteriorated.

Meanwhile, a width 14aa of the first terrace region 14a in the X-axis direction may be from the edge of the external material 11 in the −X-direction to a position before the electrode assembly accommodation region 16 in a direction oriented toward the electrode assembly accommodation region 16. The width 14aa of the first terrace region 14a in the X-axis direction may be the shortest distance in the X-axis direction from the edge of the external material 11 in the −X-direction to the electrode assembly accommodation region 16.

A height 14ab of the first terrace region 14a may be from an edge of the external material 11 in the −Z-direction to a position before the side sealing portion 15 in the direction oriented toward the side sealing portion 15. When the height 14ab of the first terrace region 14a is a length of the first terrace region 14a, a length of the first terrace region 14a may be the shortest distance in the Z-axis direction from an edge of the external material 11 in the −Z-direction to the side sealing portion 15.

A height 16b of the electrode assembly accommodation region 16 may be a height in the Z-axis direction of a region in which the electrode assembly is accommodated in the external material 11, and may be, for example, lower than the height 14ab of the first terrace region 14a. Additionally, when the height 16b of the electrode assembly accommodation region 16 is a length of the electrode assembly accommodation region 16, the length of the electrode assembly accommodation region 16 may be shorter than the length of the first terrace region 14a.

In an embodiment, the height 14ab and the width 14aa of the first terrace region 14a may be identical to a height and a width of the second terrace region 14b.

The first terrace region 14a and the second terrace region 14b may be spaced apart from each other in the X-axis direction with the electrode assembly accommodation region 16 interposed therebetween. The electrode assembly accommodation region 16 may be interposed between the first terrace region 14a and the second terrace region 14b. Additionally, the electrode assembly accommodation region 16 may be surrounded by the first terrace region 14a, the side sealing portion 15, and the second terrace region 14b.

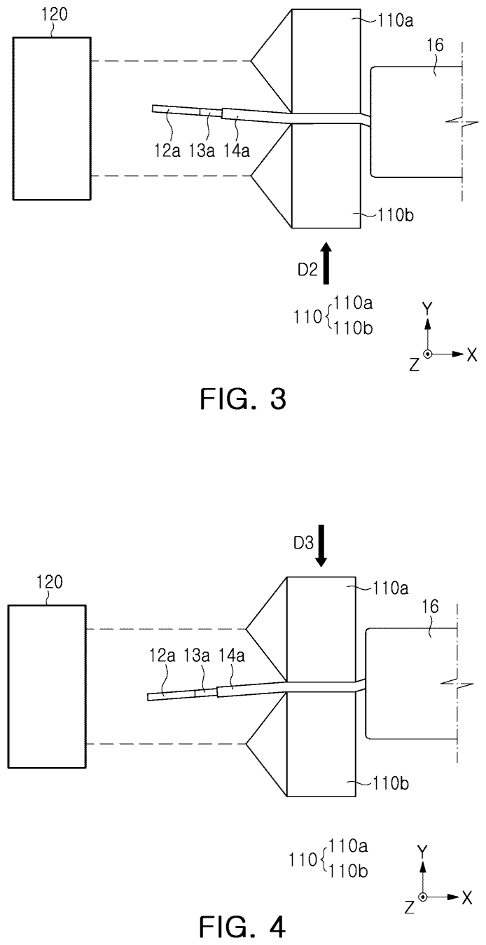

FIG. 3 illustrates an operating state of the arrangement apparatus 100 for a battery cell assembly based on an embodiment of the present disclosure as a plan view. In this case, FIG. 3, the side sealing portion 15 is excluded for the convenience of understanding. The side sealing portion 15 may be disposed in an upper portion of the electrode assembly accommodation region 16 in the Z-axis direction and an upper portion of the first terrace region 14a in the Z-axis direction, as shown in FIG. 2.

As shown in FIG. 2 and FIG. 3, as described above, the first movement portion 120 may move the terrace arrangement member 110 in a plurality of directions, and the plurality of directions may include a second direction D2, intersecting the first direction D1 on one side thereof.

The second direction D2 may be a direction that is parallel to the Y-axis and intersecting the Z-axis and the X-axis. For example, the second direction D2 may be a direction that is perpendicular to the Z-axis and the Y-axis.

Additionally, the second direction D2 may be a direction, intersecting the first direction D1. For example, the second direction D2 may be a direction that is perpendicular to the first direction D1.

The second direction D2 may be a direction for moving the first terrace region 14a in the +Y-direction. A pair of terrace arrangement members 110 clamping one first terrace region 14a may be moved in the second direction D2 by the first movement portion 120.

In an embodiment, the pair of terrace arrangement members 110 may include a first terrace arrangement member 110a in contact with one surface of the first terrace region 14a and a second terrace arrangement member 110b in contact with the other surface of the first terrace region 14a.

The first terrace arrangement member 110a and the second terrace arrangement member 110b may be moved in the second direction D2 simultaneously while in contact with the first terrace region 14a. Accordingly, the first terrace region 14a may be moved in the +Y-direction, and in this process, compressive residual stress may be applied to the first terrace region 14a.

In an embodiment, a distance by which the first terrace arrangement member 110a and the second terrace arrangement member 110b move in the second direction D2 may be less than or equal to a thickness of the battery cell 10 or the electrode assembly accommodation region 16 in the Y-axis direction. The first terrace arrangement member 110a and the second terrace arrangement member 110b may move in the second direction D2 within a width of the battery cell 10 or the electrode assembly accommodation region 16.

For example, the first movement portion 120 may move the first terrace arrangement member 110a and the second terrace arrangement member 110b in the second direction D2 so that the first terrace arrangement member 110a and the second terrace arrangement member 110b may allow a contact region between the first terrace arrangement member 110a and the first terrace region 14a and a contact region between the second terrace arrangement member 110b and the first terrace region 14a to be disposed within the width of the battery cell 10 or the electrode assembly accommodation region 16. Accordingly, deformation or damage of the first electrode lead 12a and the external material 11 may be prevented.

FIG. 4 illustrates an operating state of the arrangement apparatus 100 for a battery cell assembly based on an embodiment of the present disclosure from a plan viewpoint. In FIG. 4, the side sealing portion 15 is also excluded.

As shown in FIGS. 2 to 4, the first movement portion 120 may move the terrace arrangement member 110 in a plurality of directions, as described above. The plurality of directions may include a third direction D3 that is a direction that intersects the first direction D1 and is an opposite direction to the second direction D2.

The third direction D3 may be a direction for moving the first terrace region 14a in the −Y-direction. The first terrace arrangement member 110a and the second terrace arrangement member 110b may be moved in the third direction D3 simultaneously while in contact with the first terrace region 14a.

Accordingly, the first terrace region 14a may be moved in the −Y-direction, and in this process, compressive residual stress may be applied to the first terrace region 14a.

In an embodiment, a distance by which the first terrace arrangement member 110a and the second terrace arrangement member 110b are moved in the third direction D3 may be identical to a distance by which the first terrace arrangement member 110a and the second terrace arrangement member 110b are moved in the second direction D2.

The third direction D3 may be a direction that is parallel to the second direction D2, and may be a direction that is intersecting or perpendicular to the X-axis and the Z-axis.

In an embodiment, the first movement portion 120 may move the first terrace arrangement member 110a and the second terrace arrangement member 110b in the first direction D1, and then move the first terrace arrangement member 110a and the second terrace arrangement member 110b in the second direction D2, and then sequentially move the first terrace arrangement member 110a and the second terrace arrangement member 110b in the third direction D3. However, after moving the first terrace arrangement member 110a and the second terrace arrangement member 110b in the first direction D1, the first terrace arrangement member 110a and the second terrace arrangement member 110b may first be moved in the third direction D3, and then moved in the second direction D2.

The first movement portion 120 may move the first terrace arrangement member 110a and the second terrace arrangement member 110b in the second direction D2 multiple times, and may also move the first terrace arrangement member 110a and the second terrace arrangement member 110b in the third direction D3 multiple times. However, the number of movements is not necessarily limited by the present disclosure.

By moving the plurality of terrace arrangement members 110 in the plurality of directions by the first movement portion 120, gaps between the plurality of first terrace regions 14a may be arranged at a constant level, and compressive residual stress may be applied to the plurality of first terrace regions 14a.

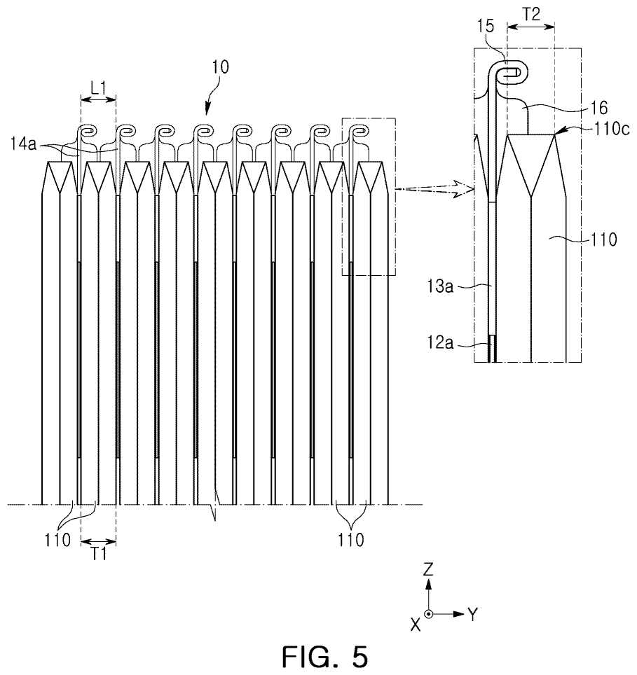

FIG. 5 illustrates an operating state of the arrangement apparatus 100 for a battery cell assembly based on another embodiment of the present disclosure as a side view.

As shown in FIG. 5, in another embodiment of the present disclosure, in a state in which a plurality of first terrace regions 14a of the plurality of battery cells 10 adjacent to each other are parallel to each other, a maximum thickness T1 of the plurality of terrace arrangement members 110 may be less than or equal to the shortest distance of the plurality of first terrace regions 14a.

In an embodiment, the plurality of terrace arrangement members 110 may all have the same shape and the same volume. Hereinafter, for the convenience of understanding, a single terrace arrangement member 110 will be described as an example, and the contents described below may be applied to a plurality of terrace arrangement members 110 in the same principle.

A maximum thickness of the terrace arrangement member 110 in the thickness direction (Y-axis direction) of the battery cell 10 may be less than or equal to a distance between a pair of first terrace regions 14a, in a state in which the first terrace regions 14a of a pair of battery cells 10 adjacent to each other are all parallel to the Z-axis and the pair of first terrace regions 14a are parallel to each other at the same time.

In an embodiment, a maximum thickness of the terrace arrangement member 110 in the thickness direction (Y-axis direction) of the battery cell 10 may be identical to the shortest distance L1 of the pair of first terrace regions 14a in the Y-axis direction.

Accordingly, as shown in FIG. 2, while the terrace arrangement member 110 moves in the first direction D1, the gaps between the plurality of first terrace regions 14a may be arranged uniformly.

Additionally, in an embodiment, in at least one of the plurality of terrace arrangement members 110, a thickness in an end 110c thereof may be a minimum thickness T2.

As shown in FIG. 2, when the first movement portion 120 moves the terrace arrangement member 110 in the first direction D1, the terrace arrangement member 110 may be moved so that the end 110c of the terrace arrangement member 110 enters between the first terrace regions 14a first.

Accordingly, even if the gap between the pair of first terrace regions 14a is less than the maximum thickness T1 of the terrace arrangement member 110, the terrace arrangement member 110 may be easily entered.

The first movement portion 120 may continuously move the terrace arrangement member 110 in the first direction D1 in a state in which the end 110c of the terrace arrangement member 110 is entered between a pair of first terrace regions 14a, and may move the terrace arrangement member 110 in the first direction D1 until a region having the maximum thickness T1 of the terrace arrangement member 110 is interposed between the pair of first terrace regions 14a.

Additionally, the first movement portion 120 may stop the movement of the terrace arrangement member 110 at a point when the end 110c of the terrace arrangement member 110 is lower in height than the side sealing portion 15 15 in the X-axis.

After the movement of the terrace arrangement member 110 in the first direction D1 is stopped, a gap in the Y-axis direction between the plurality of first terrace regions 14a may be arranged at a constant level.

In an embodiment, the first movement portion 120 may be connected to a controller, or the like, and automatically controlled, or may be manually controlled by an operator. However, this is not necessarily limited by the present disclosure.

Additionally, in an embodiment, a thickness of at least one of the plurality of terrace arrangement members 110 may linearly decrease toward the end 110c.

One end 110c of the terrace arrangement member 110 may have a minimum thickness T2, and the other end thereof may have a thickness exceeding the minimum thickness T2.

For example, the other end thereof may have a maximum thickness T1. In this case, a thickness of the terrace arrangement member 110 may linearly decrease from the other end to the one end 110c. In an embodiment, the maximum thickness T1 of the terrace arrangement member 110 may continue during a certain section. However, an inflection point at which a thickness thereof decreases in a height of the terrace arrangement member 110 in the X-axis direction is not necessarily limited by the present disclosure.

Meanwhile, as shown in FIGS. 2 to 5, the arrangement apparatus 100 for a battery cell assembly according to an embodiment of the present disclosure may move the plurality of terrace arrangement members 110 in the first direction D1 so that the first movement portion 120 may allow the ends 110c of the plurality of terrace arrangement members 110 to initially face or contact the external material 11. Additionally, the first movement portion 120 may move the terrace arrangement members 110 in the second direction D2 and the third direction D3 to pressurize the first terrace region 14a to a region having the maximum thickness T1 of the terrace arrangement members 110.

For example, the first movement portion 120 may allow the plurality of terrace arrangement members 110 to be entered in a direction oriented toward the external material 11 so that the ends 110c of the plurality of terrace arrangement members 110 initially face or contact a space between a pair of first terrace regions 14a adjacent to each other or one first terrace region 14a,

Accordingly, when the terrace arrangement member 110 moves in the first direction D1, deformation of the external material 11 may be prevented by the terrace arrangement member 110.

Additionally, when the plurality of terrace arrangement members 110 are moved in the second direction D2 and the third direction D3 in a state of clamping the first terrace region 14a with a plurality of terrace arrangement members 110, compressive residual stress may be applied to the plurality of first terrace regions 14a in a state in which the gap between the plurality of first terrace regions 14a is maintained constantly.

Accordingly, an operation of arranging the gaps between the plurality of first terrace regions 14a and an operation of applying the compressive residual stress to the plurality of first terrace regions 14a may be performed simultaneously. This may contribute to improving the production efficiency of the battery cell assembly 1.

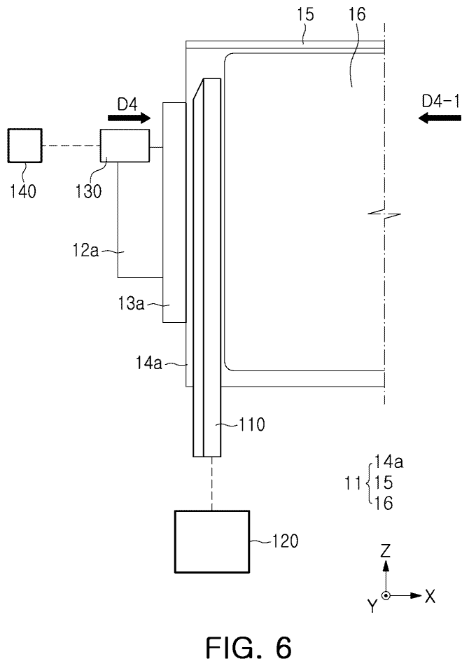

FIG. 6 illustrates an operating state of the arrangement apparatus 100 for a battery cell assembly based on another embodiment of the present disclosure as a front view. FIG. 6 is a schematic view, and in FIG. 6, a first electrode lead 12a, a first terrace region 14a, and a portion of the electrode assembly accommodation region 16 of the battery cell 10 are shown, but the second electrode lead 12b and the second terrace region 14b of the battery cell 10 may extend in the +X-direction of the electrode assembly accommodation region 16, and may have the same structure as that illustrated in FIG. 6. Additionally, the same principle as that illustrated in FIG. 6 may also be applied to a terrace arrangement member 110 and a lead arrangement member 130 disposed in the second terrace region 14b.

Additionally, in FIG. 6, only one battery cell 10 is shown for the convenience of understanding, and only one terrace arrangement member 110 and one lead arrangement member 130 are shown. However, the technical concept illustrated in FIG. 6 may be equally applied to a plurality of terrace arrangement members 110 and a plurality of lead arrangement members 130, and one terrace arrangement member 110 and one lead arrangement member 130 may be interposed between a pair of first terrace regions 14a and between a pair of first electrode leads 12a, respectively. Hereinafter, another embodiment of the present disclosure will be described based on this premise.

As shown in FIG. 6, the arrangement apparatus 100 for a battery cell assembly according to another embodiment of the present disclosure may further include a plurality of lead arrangement members 130 extending by a certain length, and a second movement portion 140 moving the plurality of lead arrangement members 130 between the plurality of electrode leads 12.

The second movement portion 140 may move the plurality of lead arrangement members 130 in a plurality of directions. In this case, the second movement portion 140 may move the plurality of lead arrangement members 130 in the same direction as a direction in which the first movement portion 120 moves the terrace arrangement member 110 at a specific point in time.

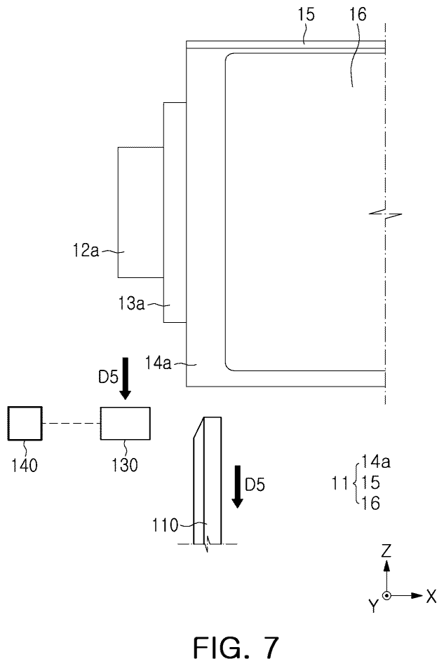

The plurality of directions in which the second movement portion 140 moves the plurality of lead arrangement members 130 may include a fourth direction D4 in which the plurality of lead arrangement members 130 are entered between the battery cells 10, and a fifth direction D5 (see FIG. 7), intersecting the fourth direction D4.

The following description will be given as an example of a single lead arrangement member 130, but the following description may be applied to a plurality of lead arrangement members 130 in the same principle.

The lead arrangement member 130 may extend by a certain length in a direction oriented toward the first electrode lead 12a. The second movement portion 140 may move the lead arrangement member 130 in the fourth direction D4 in a state in which the lead arrangement member 130 does not face the first electrode lead 12a. Accordingly, the lead arrangement member 130 may move in the direction oriented toward the first electrode lead 12a.

The fourth direction D4 may be a direction, intersecting or perpendicular to the first direction D1 illustrated in FIG. 2. For example, the second movement portion 140 may allow the lead arrangement member 130 to be entered between a pair of first electrode leads 12a from the outside of the first electrode lead 12a. In this case, an entry direction may be the fourth direction D4.

Additionally, in an embodiment, the second movement portion 140 may move the plurality of lead arrangement members 130 in the fourth direction D4 after at least one of the plurality of terrace arrangement members 110 is in close contact with the first terrace region 14a.

For example, the second movement portion 140 may move the lead arrangement member 130 in the fourth direction D4 (+X-direction) after the terrace arrangement member 110 has completed moving in the first direction D1 (+Z-direction). In this case, in the case of the second terrace region 14b illustrated in FIG. 1, the first direction D1 may be the +Z-direction, the second direction D2 may be the +Y-direction, the third direction D3 may be the −Y-direction, and the fourth direction D4 may be the −X-direction.

A movement direction of the terrace arrangement member 110 in the second terrace region 14b is the same as a movement direction of the terrace arrangement member 110 in the first terrace region 14a, but a movement direction of the lead arrangement member 130 in the second terrace region 14b and a movement direction of the lead arrangement member 130 in the first terrace region 14a may be opposite to each other only in a direction corresponding to the fourth direction D4.

That is, the direction corresponding to the fourth direction D4 of the lead arrangement member 130 in the second terrace region 14b may be a fourth-first direction D4-1. The fourth-first direction D4-1 may be a direction in which the lead arrangement member 130 gets close to the electrode lead 12 in the second terrace region 14b. The fourth direction D4 and the fourth-first direction D4-1 may be parallel to the X-axis and may be opposite directions. The fourth-first direction D4-1 is the +X-direction and may intersect or may be perpendicular to the Z-axis and the Y-axis.

Based on the first terrace region 14a, after the terrace arrangement member 110 has completed moving in the first direction D1, the second direction D2 and the third direction D3, the lead arrangement member 130 may move in the fourth direction D4 to arrange the electrode lead 12. In this case, based on the second terrace region 14b, after the terrace arrangement member 110 has completed moving in the first direction D1, the second direction D2 and the third direction D3, the lead arrangement member 130 may move in the fourth-first direction D4-1 to arrange the electrode lead 12. According thereto, after the terrace region 14 is primarily arranged, secondary precise arrangement of the electrode lead 12 may be performed. Accordingly, the arrangement efficiency of the battery cell assembly 1 may be improved.

In an embodiment of the present disclosure, the second movement portion 140 may be implemented by combinations of a motor, a gear, a ball screw, an LM guide, and the like, similarly to the first movement portion 120, and may also be implemented by a Computer Aided Engineering (CAE) such as a robot arm, Computer Aided Design (CAD), and Computer Aided Manufacturing (CAM). However, the types of the first movement portion 120 and the second movement portion 140 are not necessarily limited by the present disclosure.

Gaps between the first electrode leads 12a may be arranged uniformly by allowing the second movement portion 140 to complete moving the lead arrangement member 130 in the fourth direction D4. This may also be applied to a gap between the second electrode leads 12b.

FIG. 7 is a front view illustrating an operating state of the arrangement apparatus 100 for a battery cell assembly illustrated in FIG. 6.

As shown in FIGS. 6 and 7, after the second movement portion 140 completes moving the lead arrangement member 130 in the fourth direction D4, the second movement portion 140 may move the lead arrangement member 130 in a fifth direction D5. In this case, the first movement portion 120 may also move the terrace arrangement member 110 in the fifth direction D5.

The fifth direction D5 may be a direction in which the terrace arrangement member 110 and the lead arrangement member 130 are discharged to the outside of the battery cell 10.

The fifth direction D5 may intersect or may be perpendicular to the fourth direction D4. The fifth direction D5 may be a −Z-direction, and may be a direction, intersecting or perpendicular to the X-axis and the Y-axis.

Meanwhile, in an embodiment, the first movement portion 120 may discharge the plurality of terrace arrangement members 110 to the outside of the battery cell 10, and the second movement portion 140 may discharge the plurality of lead arrangement members 130 to the outside of the battery cell 10 by moving the plurality of lead arrangement members 130 in the same direction as the plurality of terrace arrangement members 110.

For example, the plurality of terrace arrangement members 110 and the plurality of lead arrangement members 130 may be moved simultaneously in the fifth direction D5. According thereto, after the arrangement of the first terrace region 14a and the first electrode lead 12a is completed, while the terrace arrangement member 110 and the lead arrangement member 130 are simultaneously discharged to the outside of the battery cell 10, a gap of the plurality of first terrace regions 14a and a gap of a plurality of first electrode leads 12a may be re-arranged, and also, the gap of the plurality of first terrace regions 14a and the gap of the plurality of first electrode leads 12a may be arranged simultaneously.

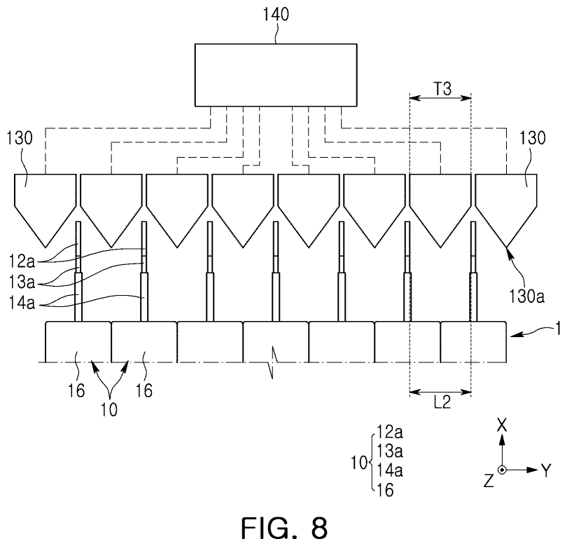

FIG. 8 illustrates an operating state of the arrangement apparatus 100 for a battery cell assembly illustrated in FIG. 6 as a plan viewpoint.

As shown in FIG. 8, one lead arrangement member 130 may be interposed between a pair of first terrace regions 14a or between a pair of first electrode leads 12a.

A plurality of lead arrangement members 130 may be introduced between the plurality of first electrode leads 12a while being spaced apart from each other by a certain distance. In this case, a separation distance of the plurality of lead arrangement members 130 in the Y-axis direction may be a target arrangement distance between a pair of first electrode leads 12a. That is, a minimum distance in the Y-axis direction between a pair of lead arrangement members 130 adjacent to each other may be greater than or equal to a thickness of the first electrode lead 12a in the Y-axis direction.

This may be applied to a plurality of terrace arrangement members 110 illustrated in FIG. 5 in the same principle. That is, the separation distance of the plurality of terrace arrangement members 110 in the Y-axis-direction may be a target arrangement distance between a pair of first terrace regions 14a. That is, a minimum distance in the Y-axis-direction between a pair of terrace arrangement members 110 adjacent to each other may be greater than or equal to a thickness of the first terrace region 14a in the Y-axis-direction.

Accordingly, a distance in the Y-axis-direction between the plurality of first electrode leads 12a that have been arranged may be at least the same as a distance in the Y-axis-direction between the plurality of lead arrangement members 130, and a distance in the Y-axis-direction between the plurality of first terrace regions 14a that have been arranged may be at least the same as a distance in the Y-axis-direction between the plurality of terrace arrangement members 110.

Additionally, in an embodiment, a maximum thickness T3 of the plurality of lead arrangement members 130 may be less than or equal to the shortest distance L2 between the plurality of electrode leads 12 in a state in which the plurality of first electrode leads 12a of the plurality of battery cells 10 adjacent to each other are parallel to each other.

In this case, the first electrode leads 12a of the plurality of battery cells 10 adjacent to each other may be parallel to the X-axis. In this state, the shortest distance L2 between the first electrode leads 12a in the Y-axis direction may be a maximum thickness T3 of one lead arrangement member 130 in the Y-axis direction. Accordingly, positions of the first electrode leads 12a may be arranged only by a process of allowing the lead arrangement member 130 to be entered between the first electrode leads 12a. This may contribute to minimizing an operation process and also to shortening the time consumed for arranging the battery cell assembly 1.

In an embodiment, a plurality of lead arrangement members 130 may be connected to a single second movement portion 140 so that a movement thereof may be controlled. However, the second movement portion 140 may be provided in plural as needed, or may be implemented by combinations of a plurality of mechanical devices.

The plurality of lead arrangement members 130 may be simultaneously controlled by the second movement portion 140, or may be individually controlled.

Additionally, in an embodiment, a thickness of an end 130a of the lead arrangement member 130 in the Y-axis direction may be a minimum thickness of the lead arrangement member 130. In this case, the end 130a of the lead arrangement member 130 may be first inserted between the first electrode leads 12a. Accordingly, the ease of introduction of the lead arrangement member 130 may be improved, and damage to the external material 11 may be minimized.

A side surface of the lead arrangement member 130 may include an inclined shape, and a thickness in the Y-axis direction may linearly decrease toward the end 130a. In this case, the surface side of the lead arrangement member 130 may be in contact with the first electrode lead 12a to arrange the first electrode lead 12a.

The shape of the end 130a of the lead arrangement member 130 may be rounded or may be changed to various shapes.

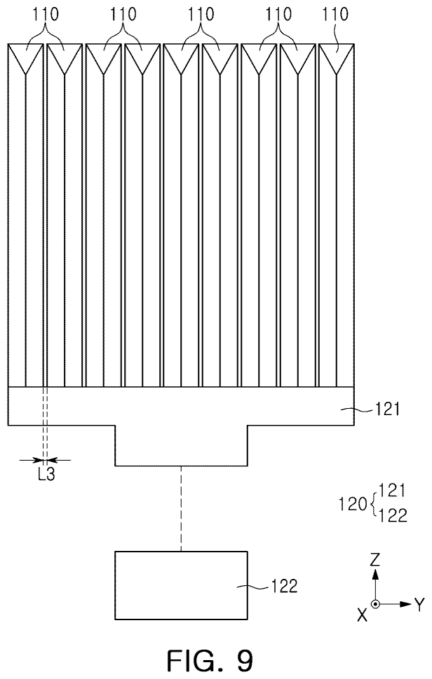

FIG. 9 is a schematic side view of an arrangement apparatus 100 for a battery cell assembly based on another embodiment of the present disclosure.

As shown in FIG. 9, in another embodiment of the present disclosure, the first movement portion 120 may include a first support frame 121 supporting the plurality of terrace arrangement members 110 to be spaced apart from each other, and a first actuator 122 connected to the first support frame 121 to move the first support frame 121.

The plurality of terrace arrangement members 110 may be fixed to the first support frame 121, and the plurality of terrace arrangement members 110 may be spaced apart from each other to have a predetermined separation distance L3 in the Y-axis direction. In this case, the separation distance L3 may be at least the same as a thickness of the first terrace region 14a and the second terrace region 14b illustrated in FIG. 1 in the Y-axis direction. Accordingly, simply by allowing the plurality of terrace arrangement members 110 to be entered between a plurality of battery cells 10, gaps in the Y-axis direction between a plurality of terrace regions 14 may be arranged uniformly.

In an embodiment, the first actuator 122 may be implemented by combinations of a motor, a gear, a ball screw, an LM guide, and the like, and may be implemented by a Computer Aided Engineering (CAE) such as a robot arm, Computer Aided Design (CAD), and Computer Aided Manufacturing (CAM).

As shown in FIGS. 2 to 7, the first movement portion 120 may be provided to move the plurality of terrace arrangement members 110 in the first direction D1 to the fifth direction D5.

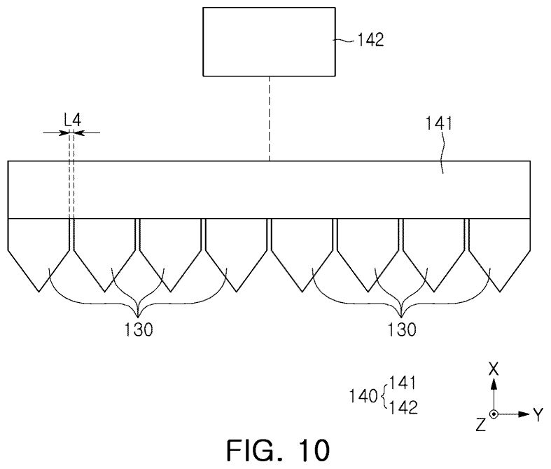

FIG. 10 is a schematic plan view of an arrangement apparatus 100 for a battery cell assembly based on another embodiment of the present disclosure.

As shown in FIG. 10, in another embodiment of the present disclosure, the second movement portion 140 may include a second support frame 141 supporting a plurality of lead arrangement members 130 and a second actuator 142 connected to the second support frame 141 to move the second support frame 141.

The plurality of lead arrangement members 130 may be fixed to the second support frame 141, and the plurality of lead arrangement members 130 may be spaced apart from each other to have a predetermined distance L4 in the Y-axis direction.

In this case, the separation distance L4 may be at least the same as a thickness of the first electrode lead 12a in the Y-axis direction and a thickness of the second electrode lead 12b in the Y-axis direction as shown in FIG. 1. Accordingly, simply by allowing the plurality of lead arrangement members 130 to be entered between the plurality of battery cells 10, gaps in the Y-axis direction between a plurality of electrode leads 12 may be arranged uniformly.

In an embodiment, the second actuator 142 may be implemented by combinations of a motor, a gear, a ball screw, an LM guide, and the like, and may be implemented by a Computer Aided Engineering (CAE) such as a robot arm, Computer Aided Design and (CAD), Computer Aided Manufacturing (CAM).

As shown in FIGS. 6 and 7, the second movement portion 140 may be provided to move the plurality of lead arrangement members 130 in the fourth direction D4 and the fifth direction D5.

Additionally, as shown in FIGS. 1 to 10, in an embodiment of the present disclosure, the plurality of terrace arrangement members 110 may be a material including at least one of a resin or mica.

Additionally, the plurality of terrace arrangement members 110 may be formed of a material having a certain rigidity, a certain strength, and a certain hardness. In this case, the plurality of terrace arrangement members 110 may be formed of the same material, and may be formed of a material having a rigidity, strength, and hardness that does not damage the external material 11.

For example, the plurality of terrace arrangement members 110 may be formed of a material including at least one of polyurethane, silica gel, a polymer material including glass fiber, or mica.

Additionally, in an embodiment, the plurality of lead arrangement members 130 may be formed of the same material as the plurality of terrace arrangement members 110. Accordingly, gaps between the battery cells 10 may be arranged without deteriorating the quality of the battery cells 10.

Additionally, as an example, when a plurality of terrace arrangement members 110 and a plurality of lead arrangement members 130 are formed of a resin, the plurality of terrace arrangement members 110 and the plurality of lead arrangement members 130 may be subject to injection-molding. However, this is not necessarily limited by the present disclosure.

On the other hand, as another aspect, the present disclosure provides an assembly apparatus 200 for a battery module that may assemble a busbar assembly 210, a sensing assembly, and the like, to a battery cell assembly, thus assembling these components as a battery module. A battery pack and/or an energy storage system may be implemented by providing such a battery module in plural.

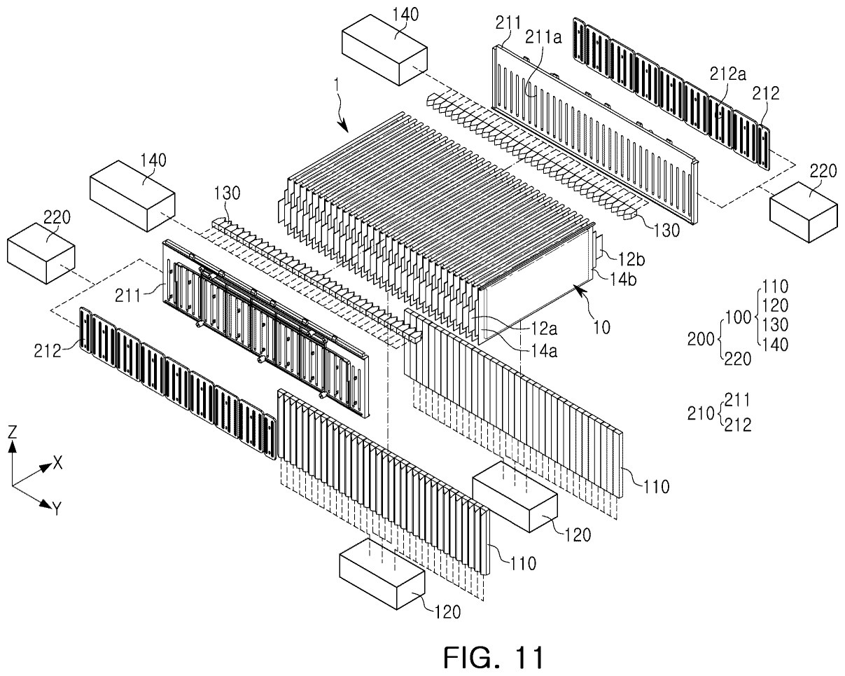

FIG. 11 is a schematic exploded perspective view of an assembly apparatus 200 for a battery module based on an embodiment of the present disclosure.

As shown in FIG. 1 and FIG. 11, an assembly apparatus 200 for a battery module according to an embodiment of the present disclosure may include a busbar movement portion 220 that moves a busbar assembly 210 in a direction oriented toward an electrode lead 12 after the arrangement apparatus 100 for a battery cell assembly and the first movement portion 120 pressurize the terrace region 14 with the plurality of terrace arrangement members 110, so as to assemble the busbar assembly 210 into a battery cell assembly 1 including a plurality of battery cells 10 in which an electrode assembly is accommodated in an external material 11 and the electrode lead 12 is exposed to the outside of the external material 11.

The busbar assembly 210 may be provided on each of a first electrode lead 12a and a second electrode lead 12b. The busbar assembly 210 may include a busbar member 212 connected to the first electrode lead 12a and the second electrode lead 12b, and a busbar plate 211 supporting the busbar member 212.

The busbar plate 211 may be provided with a first slot 211a into which the electrode lead 12 is inserted, and the busbar member 212 may also be provided with a second slot 212a facing the first slot 211a. The busbar plate 211 electrical may material include a having insulation properties, and the busbar member 212 may include a material having electrical conductivity.

The busbar member 212 may be connected to the electrode lead 12 by welding or the like, and may also be connected to a sensing assembly including a Battery Management System (BMS).

In an embodiment, the busbar member 212 and the busbar plate 211 may have been assembled as the busbar assembly 210, and may then be moved by the busbar movement portion 220.

Before assembling the busbar assembly 210 to the first electrode lead 12a and the second electrode lead 12b, a positional arrangement of the battery cell assembly 1 may be completed by the terrace arrangement member 110 and the lead arrangement member 130.

The terrace arrangement member 110 and the lead arrangement member 130 may be provided on the first electrode lead 12a, and another terrace arrangement member 110 and another lead arrangement member 130 may be provided on the second electrode lead 12b. Arrangement operations of the first electrode lead 12a and the second electrode lead 12b may be performed simultaneously, and arrangement operations of the first terrace region 14a and the second terrace region 14b may also be performed simultaneously.

The busbar movement portion 220 may be implemented by combinations of a motor, a gear, a ball screw, an LM guide, and the like, and may be implemented by a Computer Aided Engineering (CAE) such as a robot arm, Computer Aided Design (CAD), and Computer Aided Manufacturing (CAM). However, this is not necessarily limited by the present disclosure.

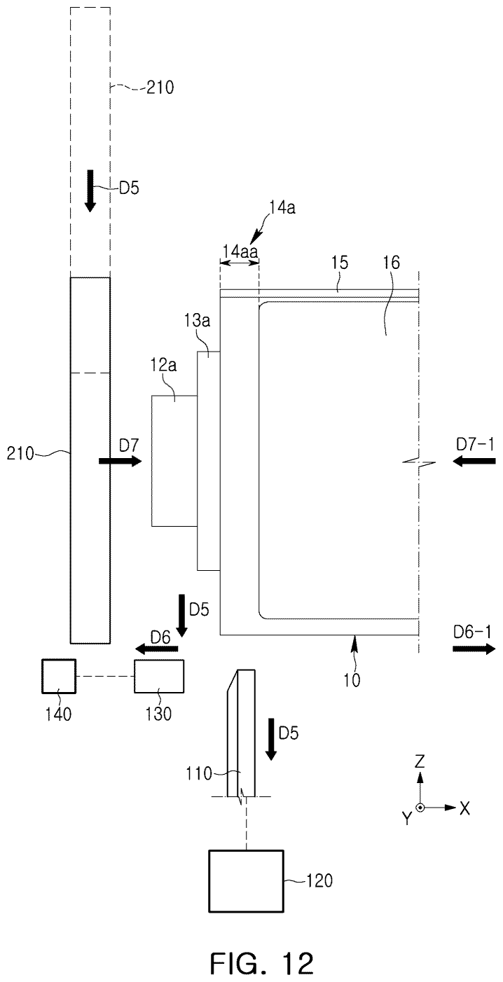

FIG. 12 is a schematic front view of the assembly apparatus 200 for a battery module illustrated in FIG. 11, and schematically illustrates the operating state.

As shown in FIGS. 11 and 12, in an embodiment, the busbar movement portion 220 may move the busbar assembly 210 while the first movement portion 120 discharges a plurality of terrace arrangement members 110 to the outside of the battery cell 10, thereby allowing the busbar assembly 210 to face the first electrode lead 12a. This may be applied to the second electrode lead 12b and the terrace arrangement member 110 and the lead arrangement member 130 matched to the second electrode lead 12b in the same principle.

The busbar movement portion 220 may move the busbar assembly 210 in the fifth direction D5 after completing the movement of the terrace arrangement member 110 and the lead arrangement member 130 in the fifth direction D5, thereby allowing the busbar assembly 210 to face the first electrode lead 12a. In this case, the fifth direction D5 may be the −Z-direction.

Additionally, if necessary, the second movement portion 140 may additionally move the lead arrangement member 130 in a sixth direction D6. Based on the first terrace region 14a, as the sixth direction D6 is a direction in which the lead arrangement member 130 moves away from the first electrode lead 12a, which is the −X-direction, the sixth direction D6 may be a direction, intersecting or perpendicular to the fifth direction D5.

In this case, the sixth direction D6 may be replaced with a sixth-first direction D6-1 based on the second terrace region 14b. The sixth direction D6 and the sixth-first direction D6-1 in the second terrace region 14b may be opposite to each other. That is, a direction corresponding to the sixth direction D6 of the lead arrangement member 130 in the second terrace region 14b may be the sixth-first direction D6-1.

The sixth-first direction D6-1 may be a direction in which the lead arrangement member 130 moves away from the electrode lead 12 in the +X-direction in the second terrace region 14b. On the other hand, the sixth direction D6 may be a direction in which the lead arrangement member 130 moves away from the electrode lead 12 in the −X-direction in the 1st terrace region 14a.

The sixth direction D6 and the sixth-first direction D6-1 are parallel to the X-axis, and may be opposite directions. The sixth-first direction D6-1 may be the +X-direction, and may intersect or may be perpendicular to the Z-axis and the Y-axis.

Based on the second terrace region 14b, after completing the movement of the lead arrangement member 130 in the fourth-first direction D4-1 (see FIG. 6) and the fifth direction D5, the lead arrangement member 130 may move in the sixth-first direction D6-1 to complete an arrangement of the second electrode lead 12b, and may be discharged to the outside of the battery cell 10. As described above, the sixth-first direction D6-1 and the sixth direction D6 are opposite to each other in the X-axis direction, and may be directions moving away from each other in the X-axis direction.

Meanwhile, in another embodiment of the present disclosure, the sensing assembly may be assembled in the busbar assembly 210.

Additionally, in an embodiment, the busbar movement portion 220 may move the busbar assembly 210 in a direction in which the first movement portion 120 discharges the plurality of terrace arrangement members 110 to the outside of the battery cell 10, that is, in the fifth direction D5. In this case, the busbar assembly 210 may be moved in a direction descending from an upper portion of the battery cell 10 toward the battery cell 10.

Accordingly, after an arrangement operation of the terrace arrangement member 110 and the lead arrangement member 130 is completed, while the terrace arrangement member 110 and the lead arrangement member 130 move in the fifth direction D5, the busbar assembly 210 may also move in the fifth direction D5 and may enter in the direction oriented toward the battery cell 10 at the same time. Accordingly, since the busbar assembly 210 enters simultaneously with discharging the terrace arrangement member 110 and the lead arrangement member 130, the assembly efficiency may be improved.

Then, if necessary, the busbar movement portion 220 may move the busbar assembly 210 in a seventh direction D7. The seventh direction D7 may be a direction in which the busbar assembly 210 approaches the first electrode lead 12a from the first terrace region 14a or a region of the first electrode lead 12a. The seventh direction D7 may be perpendicular to or may intersect the fifth direction D5 and may be parallel to the sixth direction D6. In this case, the seventh direction D7 may be parallel to the sixth direction D6 but the seventh direction D7 may be an opposite direction to the sixth direction D6 in the X-axis direction.

On the second electrode lead 12b, the busbar movement portion 220 may move the busbar assembly 210 in a seventh-first direction D7-1. The seventh-first direction D7-1 may be a direction that is parallel to the seventh direction D7 but opposite to the seventh direction D7 in the X-axis direction. The seventh-first direction D7-1 may be a direction in which the busbar assembly 210 assembled to the second electrode lead 12b approaches the second electrode lead 12b in the −X-direction. For example, the seventh-first direction D7-1 may be the −X-direction.

In a state in which the busbar assembly 210 contacts or faces the first electrode lead 12a and the second electrode lead 12b, welding of the busbar member 212 and the first electrode lead 12a and welding of the busbar member 212 and the second electrode lead 12b may be performed.

According to the above-described disclosure, before welding the busbar member 212 and the first electrode lead 12a and the second electrode lead 12b, an arrangement of the first electrode lead 12a and the second electrode lead 12b may be completed, thereby preventing the first electrode lead 12a and the second electrode lead 12b from being bent or deformed.

Accordingly, bonding properties of the busbar member 212 and the first electrode lead 12a and the second electrode lead 12b may be improved. Additionally, thermal and electrical negative events such as welding defects, short circuits, and fires may be prevented. This may contribute to improving the safety and quality of the battery module.

In FIG. 12, the busbar assembly 210 is illustrated as moving in the seventh direction D7, but in some cases, the busbar assembly 210 may rotate on an upper portion of the battery cell 10 to approach the first electrode lead 12a. However, this is not necessarily limited by the present disclosure.

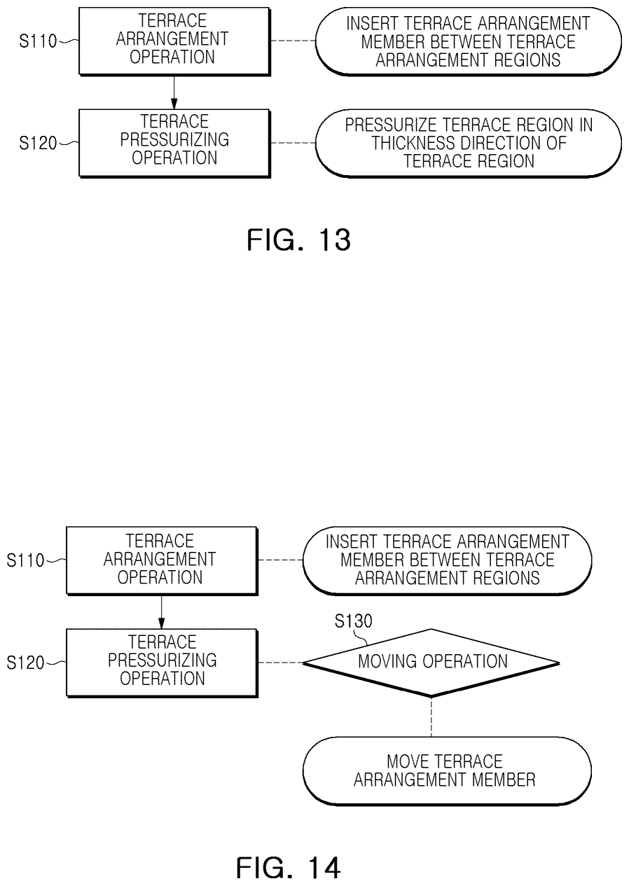

On the other hand, the present disclosure as another aspect provides an arrangement method of a battery cell assembly. FIG. 13 schematically illustrates a method for arranging a battery cell assembly according to an embodiment of the present disclosure.

As shown in FIG. 13, an arrangement method of a battery cell assembly according to an embodiment of the present disclosure may provide an arrangement method of a battery cell assembly including a plurality of battery cells in which an electrode assembly is accommodated inside an external material and an electrode lead is exposed outside the external material. In an embodiment, the arrangement method of battery cell assembly may include a terrace arrangement operation (S110) of interposing a terrace region provided in an external material between a plurality of terrace arrangement members, and a terrace pressurizing operation (S120) of pressurizing the terrace region in a thickness direction of the electrode lead with the plurality of terrace arrangement members.

As shown in FIG. 1 and FIG. 13, the terrace region 14 may include a first terrace region 14a and a second terrace region 14b. Taking the first terrace region 14a as an example, in the terrace arrangement operation (S110), the first terrace region 14a may be interposed between a plurality of terrace arrangement members 110, for example, a pair of terrace arrangement members 110.

In the terrace arrangement operation (S110), the plurality of terrace arrangement members 110 may be disposed outside the battery cell 10 and may be moved to face the battery cell 10. For example, ends of the plurality of terrace arrangement members 110 in the +Z-direction may be moved to face the battery cell 10 in a state in which the ends thereof do not face the battery cell 10.

In this case, the plurality of terrace arrangement members 110 may be spaced apart from each other by a certain distance in the thickness direction or Y-axis direction of the battery cell 10. Additionally, the plurality of terrace arrangement members 110 may be moved to face the battery cell 10 while maintaining a state in which the plurality of terrace arrangement members 110 are spaced apart from each other.

When completing the movement of the plurality of terrace arrangement members 110 in the height direction or Z-axis direction of the battery cell 10, gaps between the first terrace regions 14a of the plurality of battery cells 10 may be arranged uniformly. In this case, the gap between the first terrace regions 14a of the plurality of battery cells 10 may be a gap in the thickness direction or Y-axis direction of the battery cell 10.

In the terrace pressurizing operation (S120), a pair of terrace arrangement members 110 may contact one side and the other side of the first terrace region 14a or may pressurize the one side and the other side thereof.

In an embodiment, the terrace pressurizing operation (S120) may be performed after the terrace arrangement operation (S110) is completed.

In the terrace pressurizing operation (S120), a pair of terrace arrangement members 110 may pressurize the first terrace region 14a in opposite directions. For example, among the pair of terrace arrangement members 110, each of the terrace arrangement members 110 may move in a direction closer to the first terrace region 14a. In this case, the first terrace region 14a may be pressurized by the pair of terrace arrangement members 110.

FIG. 14 schematically illustrates an arrangement method of a battery cell assembly based on another embodiment of the present disclosure.

As shown in FIG. 3, FIG. 4 and FIG. 14, in an embodiment, the terrace pressurizing operation (S120) may include a moving operation (S130) of moving the plurality of terrace arrangement members 110 in a state in which the terrace region 14 (see FIG. 1) is pressurized by the plurality of terrace arrangement members 110.

In the moving operation (S130), the plurality of terrace arrangement members 110 may be moved in the second direction D2 and the third direction D3 in a state in which the first terrace region 14a is pressurized. The plurality of terrace arrangement members 110 may be moved in the same direction. Accordingly, the first terrace region 14a may be moved in the second direction D2 and the third direction D3 in state of being interposed between the plurality of terrace arrangement members 110 or in a state of being pressurized by the plurality of terrace arrangement members 110. According to the moving operation (S130), compressive residual stress may be applied to the first terrace region 14a. Therefore, occurrence of a springback phenomenon of the external material (11 of FIG. 1) may be prevented. Due to the suppression of the occurrence of the springback, the quality of the battery cell 10 and the battery cell assembly 1 may be improved.

The contents described above are merely examples of applying the principles of the present disclosure, and other components may be further included or substituted and applied without departing from the scope of the present disclosure.

What is claimed is:

1. An arrangement apparatus for a battery cell assembly, comprising: to arrange the battery cell assembly including a plurality of battery cell in which an electrode assembly is accommodated inside an external material and an electrode lead is exposed to an outside of the external material,
a plurality of terrace arrangement members spaced apart from each other and interposed between the plurality of battery cells; and
a first movement portion moving the plurality of terrace arrangement members in a plurality of directions and bringing the plurality of terrace arrangement members into contact with a terrace region of the external material.

2. The arrangement apparatus for a battery cell assembly of claim 1, further comprising:
a plurality of lead arrangement members extending in a direction oriented toward the electrode leads; and
a second movement portion moving the plurality of lead arrangement members between the plurality of electrode leads.

3. The arrangement apparatus for a battery cell assembly of claim 1, wherein the first movement portion is configured to,
move the plurality of terrace arrangement members in a first direction, intersecting a thickness direction of the electrode lead and allowing the plurality of terrace arrangement members to be entered between the battery cells, and
move the plurality of terrace arrangement members in the thickness direction of the electrode lead, or a direction, intersecting the thickness direction of the electrode leads with respect to the first direction.

4. The arrangement apparatus for a battery cell assembly of claim 3, wherein the first movement portion moves the plurality of terrace arrangement members in a second direction, intersecting the first direction on one side thereof, and in a third direction, intersecting the first direction on the other side thereof, and opposite to the second direction.

5. The arrangement apparatus for a battery cell assembly of claim 4, wherein in state in which a plurality of terrace regions of a plurality of battery cells adjacent to each other are parallel to each other, a maximum thickness of the plurality of terrace arrangement members is less than or equal to a shortest distance of the plurality of terrace regions.

6. The arrangement apparatus for a battery cell assembly of claim 3, wherein in at least one of the plurality of terrace arrangement members, a thickness of an end thereof is a minimum thickness.

7. The arrangement apparatus for a battery cell assembly of claim 6, wherein at least one of the plurality of terrace arrangement members has a thickness that linearly decreases toward an end of the terrace arrangement member.

8. The arrangement apparatus for a battery cell assembly of claim 5, wherein the first movement portion is configured to,
move the plurality of terrace arrangement members in the first direction so that ends of the plurality of terrace arrangement members initially face or contact the external material, and
move the plurality of terrace arrangement members in the second direction and the third direction so as to pressurize the terrace region with a region having the maximum thickness.

9. The arrangement apparatus for a battery cell assembly of claim 1, wherein the plurality of terrace arrangement members are formed of a material including at least one of a resin or mica.

10. The arrangement apparatus for a battery cell assembly of claim 2, wherein the second movement portion moves the plurality of lead arrangement members in a fourth direction, intersecting a thickness direction of the electrode lead and allowing the plurality of lead arrangement members to be entered between the battery cells, and moves the plurality of lead arrangement members in the thickness direction of the electrode lead or a fifth direction, intersecting a height direction of the electrode lead with respect to the fourth direction.

11. The arrangement apparatus for a battery cell assembly of claim 10, wherein the second movement portion moves the plurality of lead arrangement members in the fourth direction after at least one of the plurality of terrace arrangement members is in close contact with the terrace region.

12. The arrangement apparatus for a battery cell assembly of claim 2, wherein in state in which a plurality of electrode leads of a plurality of battery cells adjacent to each other are parallel to each other, a maximum thickness of the plurality of lead arrangement members is less than or equal to a shortest distance between the plurality of electrode leads.

13. The arrangement apparatus for a battery cell assembly of claim 1, wherein the first movement portion includes:
a first support frame supporting the plurality of terrace arrangement members to be spaced apart from each other; and
a first actuator connected to the first support frame and moving the first support frame.

14. The arrangement apparatus for a battery cell assembly of claim 2, wherein the second movement portion includes:
a second support frame supporting the plurality of lead arrangement members; and
a second actuator connected to the second support frame and moving the second support frame.

15. The arrangement apparatus for a battery cell assembly of claim 2, wherein the first movement portion discharges the plurality of terrace arrangement members to the outside of the battery cell, and
the second movement portion discharges the plurality of lead arrangement members to the outside of the battery cell by moving the plurality of lead arrangement members in the same direction as the plurality of terrace arrangement members.

16. An assembly apparatus for a battery module, comprising: to assemble a busbar assembly to a battery cell assembly including a plurality of battery cell in which an electrode assembly s accommodated inside an external material and an electrode lead is exposed to an outside of the external material,
the arrangement apparatus for a battery cell assembly of claim 1; and
a busbar movement portion moving the busbar assembly in a direction oriented toward the electrode lead after the first movement portion pressurizes the terrace region with the plurality of terrace arrangement members.

17. The assembly apparatus for a battery module of claim 16, wherein the busbar movement portion moves the busbar assembly while the first movement portion discharges the plurality of terrace arrangement members to the outside of the battery cell, so that the busbar assembly faces the electrode lead.

18. The assembly apparatus for a battery module of claim 17, wherein the busbar movement portion moves the busbar assembly in a direction in which the first movement portion discharges the plurality of terrace arrangement members to the outside of the battery cell.

19. An arrangement method of a battery cell assembly including a plurality of battery cell in which an electrode assembly is accommodated inside an external material and an electrode lead is exposed to an outside of the external material, the arrangement method comprising:
a terrace arrangement operation of interposing a terrace region provided in the external material between a plurality of terrace arrangement members; and
a terrace pressurizing operation of pressurizing the terrace region with a plurality of terrace arrangement members in a thickness direction of the electrode lead.

20. The arrangement method of a battery cell assembly of claim 19, wherein the terrace pressurizing operation includes:
a moving operation of moving the plurality of terrace arrangement members in a state in which the terrace region is pressurized with the plurality of terrace arrangement members.
